(19) United States
(12) Patent Application Publication
(10) Pub. No.: US 2026/0252205 A1
(43) Pub. Date: Aug. 27, 2026

(54) METHOD, APPARATUS, DEVICE AND STORAGE MEDIUM FOR INTERFACE INTERACTION

(71) Applicants: Lemon Inc., Grand Cayman (KY); Beijing Zitiao Network Technology Co., Ltd., Beijing (CN)

(72) Inventors: Long Jiang, Culver City, CA (US); Runze Zhang, Los Angeles, CA (US); Shiyuan Liu, Beijing (CN); Minqi Luo, Culver City, CA (US)

(21) Appl. No.: 19/549,823

(22) Filed: Feb. 25, 2026

(30) Foreign Application Priority Data
Feb. 25, 2025 (WO) PCT/CN2025/079050

(51) Int. Cl. G06F 3/0481; G06F 3/04845

(52) U.S. Cl. CPC G06F 3/0481; G06F 3/04845

(57) ABSTRACT

Embodiment of th disclosure relates to a method, apparatus, device and storage medium for interface interaction. The method proposed herein includes: presenting an interaction interface comprising an input control for inputting a prompt; detecting whether information input in the input control comprises a target field of a predetermined type; adjusting a display style of the target field in the input control in response to the input information comprising the target field of the predetermined type; and providing auxiliary information associated with the target field in response to receiving a predetermined operation for the target field. In this way, the embodiments of the disclosure may improve the quality of an input prompt.

### CROSS-REFERENCE

This application claims priority to International Application No. PCT/CN2025/079050, filed on Feb. 25, 2025 and entitled ‘METHOD, APPARATUS, DEVICE AND STORAGE MEDIUM FOR INTERFACE INTERACTION’, which is incorporated herein by reference in its entirety.

### FIELD

Example embodiments of the present disclosure generally relate to the field of computers, and in particular, to a method, apparatus, device, and computer-readable storage medium for interface interaction.

### BACKGROUND

In recent years, the generation model technology has developed rapidly, and users may utilize generation models to perform various types of generation tasks. For example, a user may utilize a generation model to perform tasks such as text generation, effect generation, video generation, and the like. In the process of using the generation model, the quality of the prompts input by the user will directly determine the quality of the generated content.

### SUMMARY

In a first aspect of the present disclosure, a method for interface interaction is provided. The method includes: presenting an interaction interface including an input control for inputting a prompt; detecting whether information input in the input control includes a target field of a predetermined type; adjusting a display style of the target field in the input control in response to the input information including the target field of the predetermined type; and providing auxiliary information associated with the target field in response to receiving a predetermined operation for the target field.

In a second aspect of the present disclosure, an apparatus for interface interaction is provided. The apparatus includes: a presenting module configured to present an interaction interface including an input control for inputting a prompt; a detecting module configured to detect whether information input in the input control includes a target field of a predetermined type; an adjusting module configured to adjust a display style of a target field in the input control in response to the input information including the target field of the predetermined type; and a providing module configured to provide auxiliary information associated with the target field in response to receiving a predetermined operation for the target field.

In a third aspect of the present disclosure, an electronic device is provided. The device includes at least one processor; and at least one memory coupled to the at least one processor and storing instructions for execution by the at least one processor, the instructions, when executed by the at least one processor, causing the electronic device to perform the method the first aspect.

In a fourth aspect of the present disclosure, a computer-readable storage medium is provided. The computer-readable storage medium has a computer program stored thereon, the computer program being executable by a processor to implement the method of the first aspect.

In a fifth aspect of the present disclosure, there is provided a computer program product tangibly stored in a computer storage medium and including computer executable instructions that, when executed by a device, cause the device to perform the method of the first aspect.

It would be appreciated that the content described in this content section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, where:

FIG. 1 illustrates a schematic diagram of an example environment in which embodiments according to the present disclosure may be implemented;

FIGS. 2A-2C illustrate example interfaces in accordance with some embodiments of the present disclosure;

FIG. 3 illustrates an example process according to some embodiments of the present disclosure;

FIG. 4 illustrates a flowchart of an example process of interface interaction according to some embodiments of the present disclosure;

FIG. 5 illustrates a schematic structural block diagram of an example apparatus for interface interaction according to some embodiments of the present disclosure; and

FIG. 6 illustrates a block diagram of an electronic device capable of implementing various embodiments of the present disclosure.

### DETAILED DESCRIPTION

Embodiments of the present disclosure would be described in more detail below with reference to the accompanying drawings. While certain embodiments of the present disclosure are illustrated in the accompanying drawings, it would be appreciated that the present disclosure may be implemented in various forms and would not be construed as limited to the embodiments set forth herein. Rather, these embodiments are provided for a more thorough and complete understanding of the present disclosure. It would be appreciated that the drawings and embodiments of the present disclosure are for example purposes only and are not intended to limit the scope of the present disclosure.

It would be appreciated that the title of any section/subsection provided herein is not limiting. Various embodiments are described throughout, and any type of embodiments may be included in any section/subsection. Furthermore, the embodiments described in any section/subsection may be combined in any manner with the same section/subsection and/or any other embodiment described in different sections/subsections.

In the description of the embodiments of the present disclosure, the terms ‘including’ and the like would be understood to include ‘including but not limited to’. The term ‘based on’ would be understood as ‘based at least in part on’. The terms ‘one embodiment’ or ‘the embodiment’ would be understood as ‘at least one embodiment’. The term ‘some embodiments’ would be understood as ‘at least some embodiments’. Other explicit and implicit definitions may also be included below. The terms ‘first,’ ‘second,’ and the like may refer to different or identical objects. Other explicit and implicit definitions may also be included below.

Embodiments of the present disclosure may relate to data of a user, obtaining and/or use of data, and the like. These aspects all follow the corresponding laws and regulations and related regulations. In the embodiments of the present disclosure, all data collection, acquisition, processing, handling, processing, reposting, use, and the like are carried out on the premise of the knowledge and confirmation of the user. Accordingly, when implementing the embodiments of the present disclosure, the types of the data or information that may be involved, the usage scope, the usage scenario, and the like would be notified to the user and obtain the authorization of the user in an appropriate manner according to the relevant laws and regulations. The specific notification and/or authorization manner may vary according to actual situations and application scenarios, and the scope of the present disclosure is not limited in this respect.

According to the solutions in the present specification and the embodiments, for example, personal information processing is involved, processing may be performed on the premise of having a legality basis (for example, obtaining consent of a personal information subject, or necessary for performing a fulfillment contract), and processing only within a specified or agreed range. The user rejects personal information other than necessary information required by the basic function and may not affect the basic function of the user.

In recent years, the generation model technology has developed rapidly, and users may utilize generation models to perform various types of generation tasks. For example, a user may utilize a generation model to perform tasks such as text generation, effect generation, video generation, and the like. In the process of using the generation model, the quality of the prompts input by the user will directly determine the quality of the generated content.

Embodiments of the present disclosure provide an interface interaction solution. According to the solution, an interaction interface including an input control for inputting a prompt may be presented,; whether information input in the input control includes a target field of a predetermined type is detected; a display style of the target field in the input control is detected in response to the input information including the target field of the predetermined type; and auxiliary information associated with the target field is provided in response to receiving a predetermined operation for the target field.

In this way, the embodiments of the present disclosure may adjust the display style of the target field in the information input in the input control, and provide auxiliary information associated with the target field in response to a predetermined operation of the user for the target field. Therefore, the embodiment of the present disclosure may improve the quality of the prompts input by the user and reduce the learning cost of the user using the generation model.

Various example implementations of this solution are described in detail below in conjunction with the accompanying drawings.

### Example Environment

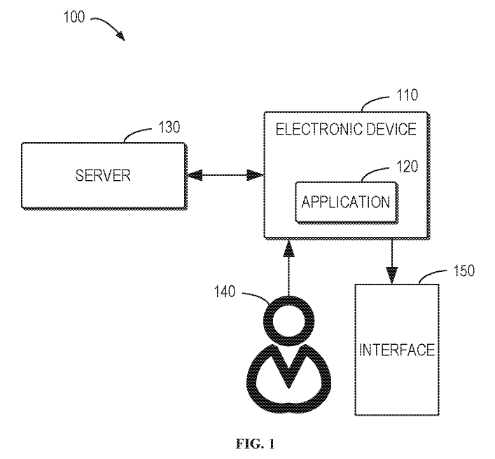

FIG. 1 illustrates a schematic diagram of an example environment 100 in which embodiments of the present disclosure may be implemented. As illustrated in FIG. 1, the example environment 100 may include an electronic device 110.

In this example environment 100, the electronic device 110 may run an application 120 that supports interface interaction. The application 120 may be any suitable type of application for interface interaction, examples of which may include, but are not limited to: a video application, a social application, or a further suitable application. A user 140 may interact with the application 120 via the electronic device 110 and/or its attachment device.

In the environment 100 of FIG. 1, if the application 120 is in an active state, the electronic device 110 may present, via the application 120, an interface 150 for supporting interface interaction.

In some embodiments, the electronic device 110 communicates with the server 130 to enable provisioning of services to the application 120. The electronic device 110 may be any type of mobile terminal, fixed terminal, or portable terminal, including a mobile phone, a desktop computer, a laptop computer, a notebook computer, a netbook computer, a tablet computer, a media computer, a multimedia tablet, a palmtop computer, a portable game terminal, a VR/AR device, a personal communication system (PCS) device, a personal navigation device, a personal digital assistant (PDA), an audio/video player, a digital camera/camcorder, a positioning device, a television receiver, a radio broadcast receiver, an electronic book device, a gaming device, or any combination of the foregoing, including accessories and peripherals of these devices, or any combination thereof. In some embodiments, the electronic device 110 may also support any type of interface for a user (such as a “wearable” circuit, etc.).

The server 130 may be a standalone physical server, or may be a server cluster or a distributed system composed of a plurality of physical servers, or may be a cloud server that provides basic cloud computing services such as cloud services, cloud databases, cloud computing, cloud functions, cloud storage, network services, cloud communications, middleware services, domain name services, security services, content distribution networks, big data and artificial intelligence platforms. The server 130 may include, for example, a computing system/server, such as a mainframe, an edge computing node, a computing device in a cloud environment, or the like. The server 130 may provide background services for applications 120 that support content presentation in the electronic device 110.

A communication connection may be established between the server 130 and the electronic device 110. The communication connection may be established in a wired manner or a wireless manner. The communication connection may include, but is not limited to, a Bluetooth connection, a mobile network connection, a Universal Serial Bus (USB) connection, a Wireless Fidelity (Wi-Fi) connection, and the like, and the embodiments of the present disclosure are not limited in this aspect. In an embodiment of the present disclosure, the server 130 and the electronic device 110 may implement signaling interaction through a communication connection therebetween.

It would be appreciated that the structures and functions of the various elements in the environment 100 are described for example purposes only and do not imply any limitation to the scope of the present disclosure.

Some example embodiments of the present disclosure will be described below with continued reference to the accompanying drawings.

### Example Interaction

The process of example interface interaction according to embodiments of the present disclosure will be described below with reference to the accompanying drawings.

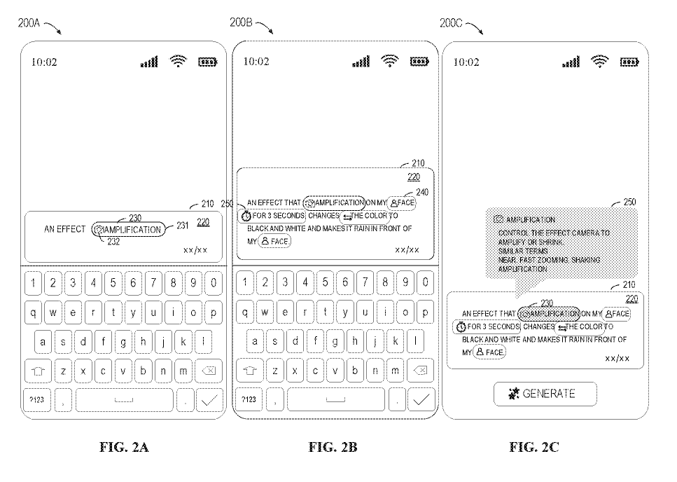

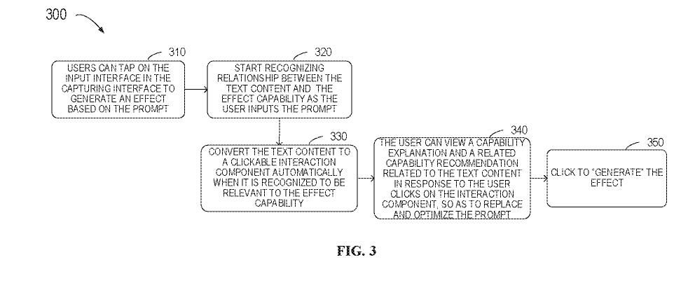

FIGS. 2A-2C illustrate example interfaces 200A-200C, in accordance with some embodiments of the present disclosure. The interfaces 200A-200C may be provided by the electronic device 110 shown in FIG. 1.

In an embodiment of the present disclosure, the electronic device 110 presents an interaction interface including an input control for inputting a prompt. In some embodiments, such a prompt may be used to describe an effect to be generated, and such a prompt may be, for example, “a dog walking alone in a raining street”. In some further embodiments, such a prompt may further indicate any type of text contents input by the user in the input control, for example, a session content of the user in the interaction application.

In some other scenarios, such a prompt may also be provided to a generation model to perform other types of generation tasks, such as generating an image, generating code, generating a video, and the like.

FIG. 2A illustrates an interaction interface according to some embodiments of the present disclosure. As shown in FIG. 2A, the electronic device 110 may edit an effect to be generated in the interaction interface 200A. Specifically, the electronic device 110 may provide an input control 210 in the interaction interface 200A to receive a prompt 220 input by the user to generate and/or edit the effect accordingly. In some embodiments, such input control 210 may be used to receive any suitable type of message sent by a user, such as a text message, a speech message, or the like. For ease of description, the following describes the text message by using the user as an example.

In order to improve user interaction efficiency, in an embodiment of the present disclosure, the electronic device 110 detects whether information input in the input control includes a target field of a predetermined type. In some embodiments, such input information may indicate information input by the user dynamically in the input control 210. Specifically, the electronic device 110 may obtain the information input in the input control 210 in response to the user inputting the prompt 220 in the input control 210. Further, the electronic device 110 may detect, by using a first model, whether the information input by the user includes the target field of the predetermined type. The first model may include any suitable generation model, such as a language model.

In some embodiments, the target field of the predetermined type may be associated with a generation scenario of the prompt. For example, in an effect generation scenario, such a target field may include an effect parameter for controlling the effect generation. In a video generation scenario, such target fields may include a parameter for controlling the video generation.

In some embodiments, the target field may correspond to an effect parameter for controlling the effect generation, such effect parameter may include a first-type parameter related to a material content for generating an effect, and as an example, the first parameter may be, for example, an image parameter, an expression parameter, an audio parameter, a music parameter, and the like; such effect parameter may further include a second-type parameter related to the interaction process of the effect to be generated, as an example, such second parameter may be, for example, a time parameter, a color parameter, and the like; such effect parameter may further include a third-type parameter related to the processing logic of the effect to be generated, as an example, such a third-type parameter may be, for example, a parameter such as amplification and reduction.

Taking FIG. 2A as an example, in response to the user inputting the prompt 220 in the input control 210, the electronic device 110 may obtain the input information in the input control 210, and may detect, by using a first model, whether the input information includes the target field of the predetermined type. As an example, such the target field of the predetermined type may be, for example, a third parameter related to the processing logic of the effect to be generated, for example, amplification.

In order to enable the user to view the target field of the predetermined type in real time in the input control 210 while the prompt is being input, in the embodiment of the present disclosure, the electronic device 110 adjusts a display style of a target field in the input control 210 in response to the input information including the target field of the predetermined type.

To enable user interaction with the target field, in some embodiments, the electronic device 110 may present, in the input control 210, an interaction component 231 corresponding to the target field 230. Such interaction component 231 may display the target field 230. Further, the electronic device 110 may present, in response to a selection of the interaction component 231 by the user, the auxiliary information associated with the target field 230.

To facilitate the user to more intuitively view the type corresponding to the target field, in some other embodiments, the electronic device 110 may present, in the input control 210, an identification element 232 corresponding to the target field 230. Such identification element 232 may indicate the type of the target field 230. In some embodiments, such identification element 232 may include a predetermined graphical element corresponding to the type of the target field 230. As an example, such a predetermined graphical element may be a graphical element determined by the electronic device 110 in the graphical element library based on the type of the target field 230. In addition, the predetermined graphic element may further be, for example, a graphic element generated by the electronic device 110 based on the type of the target field 230.

In order to highlight the target field, in still other embodiments, the electronic device 110 may display the target field 230 in a target style in the input control 210 in response to the input information including the target field 230 of the predetermined type, for example, the target field 230 may be processed to be highlighted or bolded to be different from other contents in the input information.

In some embodiments, the user may modify part of the text in the input information or add additional text to the input information, etc. In this process, the electronic device 110 may detect, by using the first model, whether the part of the text and/or the additional text include the target field of the predetermined type, and further, the electronic device 110 adjusts the display style of the target field in the input control 210 in response to the part of the text and/or the additional text including the target field of the predetermined type. Taking FIG. 2B as an example, in response to a user adding an additional text to the prompt 220, the electronic device 110 may detect whether the additional text includes a target field of a predetermined type with the first model, for example, a field 240 and a field 250. Further, the electronic device 110 may adjust a display style of the target field in the input control 210, so that the user may view the target field and may implement the interaction with the target field.

Further, in the embodiment of the present disclosure, the electronic device 110 provides auxiliary information associated with the target field in response to receiving a predetermined operation for the target field. In some embodiments, such predetermined operation may be, for example, a click operation, a double-click operation, a hover operation, a slide operation, or the like. The present disclosure is not intended to limit the form of the predetermined operation.

Specifically, the electronic device 110 may present an interaction panel corresponding to the target field in response to receiving the predetermined operation for the target field. Taking FIG. 2C as an example, the electronic device 110 may present an interaction panel 250 corresponding to the target field 230 in response to receiving a single-click operation of the user for the target field 230.

In some other embodiments, in response to the user completing the input for the prompt in the input control 210, the electronic device 110 may directly present the interaction panel corresponding to the target field at a predetermined position. As an example, the electronic device 110 may directly present the interaction panel corresponding to the target field at the first position of the prompt in response to the user completing the input for the prompt in the input control 210.

In order to improve the efficiency and quality of an effect to be generated, the electronic device 110 may provide, in the interaction panel 250, a set of candidate items associated with the target field as the auxiliary information. In some embodiments, such set of candidate items may be generated by using a second model based on the input information or the target field. Such second model may include any suitable machine learning model, e.g., a generation model. As an example, the electronic device 110 may generate, based on the target field 230 (for example, amplification), a set of candidate items corresponding to the target field with the second model, for example, near, fast zooming, and shaking amplification.

Further, the electronic device 110 may update the target field in the input control 220 to a selected target candidate item in response to a selection of the target candidate item in the set of candidate items. As an example, in response to a selection of a user of a target candidate item (e.g., fast zooming) in a set of candidate items, the electronic device 110 may update the target field 230 (e.g., amplification) to the target candidate item, and may adjust a display style of the target candidate item in the input control 210.

In order to improve the understanding of the target field by the user and improve the quality of an effect to be generated, in some embodiments, such auxiliary information may further include an interpreted content and/or modification suggestion for the target field.

With continued reference to FIG. 2C, as an example, in response to receiving a single-click operation of the user for the target field 230, the electronic device 110 may present the explanatory content for the target field 230 (for example, enlarged) in the interaction panel 250, for example, controlling the effect camera to amplify or shrink. As another example, in response to receiving a single-click operation of the user for the target field 230, the electronic device 110 may present, in the interaction panel 250, a modification suggestion for the target field 230 (for example, zooming in), for example, the target field 230 may be replaced with content such as near, fast zooming, or shaking amplification.

Based on this manner, the embodiments of the present disclosure may help a user more efficiently understand and learn a prompt for describing an effect, thereby greatly reducing the learning cost of the user, and improving the generation efficiency and the generation quality of the effect.

FIG. 3 illustrates an example process according to some embodiments of the present disclosure, which will be described below with reference to FIG. 3.

In block 310, the electronic device 110 may present a capturing interface of the target application, and further, the user may select an input interface in the capturing interface that generates an effect based on the prompt, the input interface including an input control. In block 320, the electronic device 110 may identify a relationship between the text content input by the user and the effect capability in a process in which the user inputs the prompt based on the input control. In block 330, the electronic device 110, in response to recognizing a part of the text content that is relevant to the effect capability, may automatically convert that text content into a clickable interaction component style.

Further, in block 340, the electronic device 110 may present a capability explanation and a related capability recommendation related to the text content in response to a click of the user for the interaction component. Further, the user may replace and optimize the prompt based on the capability explanation and/or the capability recommendation. In block 350, the electronic device 110 may generate a target effect corresponding to the prompt in response to the trigger of the user for the predetermined control in the input interface. Based on the process, the learning cost of the user may be greatly reduced, and the generation efficiency and the generation quality of the effect are improved.

In this way, the embodiments of the present disclosure may adjust a display style of a target field in information input in an input control, and provide auxiliary information associated with the target field in response to a predetermined operation of a user for the target field. Therefore, the embodiment of the present disclosure may improve the quality of the prompt input by the user and reduce the learning cost of the user using the generation model.

### Example Processes

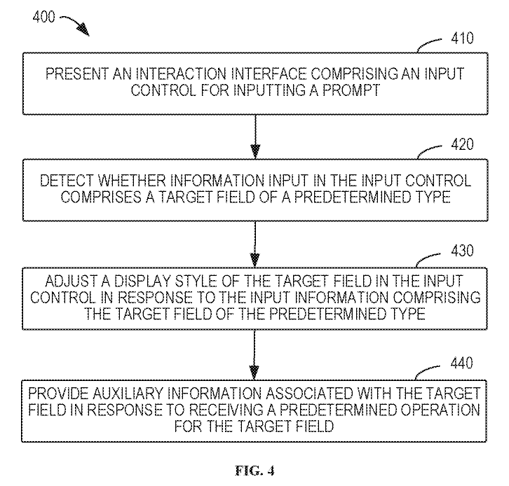

FIG. 4 illustrates a flowchart of an example interface interaction process 400 according to some embodiments of the present disclosure. Process 400 may be implemented at electronic device 110. The process 400 is described below with reference to FIG. 1.

As shown in FIG. 4, at block 410, the electronic device 110 presents an interaction interface including an input control for inputting a prompt.

In block 420, the electronic device 110 detects whether information input in the input control includes a target field of a predetermined type.

In block 430, the electronic device 110 adjusts a display style of the target field in the input control in response to the input information including the target field of the predetermined type.

At block 440, the electronic device 110 provides auxiliary information associated with the target field in response to receiving a predetermined operation for the target field.

In some embodiments, the prompt is for describing an effect to be generated, and the target field of the predetermined type corresponds to an effect parameter for controlling an effect generation.

In some embodiments, the effect parameter includes at least one of: a first-type parameter related to a material content for generating an effect, a second-type parameter related to an interaction process of the effect to be generated, or a third-type parameter related to a processing logic of the effect to be generated.

In some embodiments, detecting whether the information input in the input control includes the target field of the predetermined type includes: obtaining the input information in the input control; and detecting, by using a first model, whether the input information includes the target field of the predetermined type.

In some embodiments, adjusting the display style of the target field in the input control includes: presenting, in the input control, an interaction component corresponding to the target field, the interaction component displaying the target field.

In some embodiments, adjusting the display style of the target field in the input control includes: presenting, in the input control, an identification element corresponding to the target field, the identification element indicating a type of the target field.

In some embodiments, the identification element includes a predetermined graphical element corresponding to the type.

In some embodiments, providing the auxiliary information associated with the target field includes: presenting an interaction panel corresponding to the target field in response to receiving the predetermined operation for the target field; and providing, in the interaction panel, a set of candidate items associated with the target field as the auxiliary information.

In some embodiments, the process 400 further includes: updating the target field in the input control to a selected target candidate item in response to a selection of the target candidate item in the set of candidate items.

In some embodiments, the set of candidate items are generated by using a second model based on the input information or the target field.

In some embodiments, the auxiliary information includes an interpreted content and/or modification suggestion for the target field.

### Example Apparatus and D evice

Embodiments of the present disclosure also provide a corresponding apparatus for implementing the above methods or processes. FIG. 5 illustrates a schematic structural block diagram of an example apparatus 500 for effect generation according to some embodiments of the present disclosure. The apparatus 500 may be implemented or included in the electronic device 110. The various modules/components in the apparatus 500 may be implemented by hardware, software, firmware, or any combination thereof.

As shown in FIG. 5, the apparatus 500 includes a presenting module 510 configured to present an interaction interface including an input control for inputting a prompt; a detecting module 520 configured to detect whether information input in the input control includes a target field of a predetermined type; an adjusting module 530 configured to adjust a display style of a target field in the input control in response to the input information including the target field of the predetermined type; and a providing module 540 configured to provide auxiliary information associated with the target field in response to receiving a predetermined operation for the target field.

In some embodiments, the prompt is for describing an effect to be generated, and the target field of the predetermined type corresponds to an effect parameter for controlling an effect generation.

In some embodiments, the effect parameter includes at least one of: a first-type parameter related to a material content for generating an effect, a second-type parameter related to an interaction process of the effect to be generated, or a third-type parameter related to a processing logic of the effect to be generated.

In some embodiments, the detecting module 520 is further configured to obtain the input information in the input control; and detect, by using a first model, whether the input information includes the target field of the predetermined type.

In some embodiments, the adjusting module 530 is further configured to present, in the input control, an interaction component corresponding to the target field, the interaction component displaying the target field.

In some embodiments, the adjusting module 530 is further configured to present, in the input control, an identification element corresponding to the target field, the identification element indicating a type of the target field.

In some embodiments, the identification element includes a predetermined graphical element corresponding to the type.

In some embodiments, the providing module 540 is further configured to present an interaction panel corresponding to the target field in response to receiving the predetermined operation for the target field; and provide, in the interaction panel, a set of candidate items associated with the target field as the auxiliary information.

In some embodiments, the apparatus 500 further includes an updating module configured to update the target field in the input control to a selected target candidate item in response to a selection of the target candidate item in the set of candidate items.

In some embodiments, the set of candidate items are generated by using a second model based on the input information or the target field.

In some embodiments, the auxiliary information includes an interpreted content and/or modification suggestion for the target field.

The modules included in the apparatus 500 may be implemented in various manners, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 500 may be implemented, at least in part, by one or more hardware logic components. By way of example and not limitation, example types of hardware logic components that may be used include field programmable gate arrays (FPGAs), application specific integrated circuits (ASICs), application specific standards (ASSPs), system-on-a-chip (SOCs), complex programmable logic devices (CPLDs), and the like.

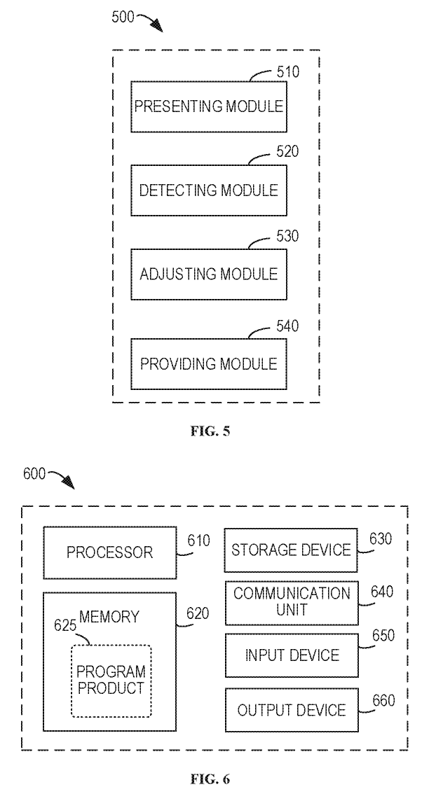

As shown in FIG. 6, the electronic device 600 is in a form of a general-purpose electronic device. Components of the electronic device 600 may include, but are not limited to, one or more processors or processing units 610, memory 620, storage device 630, one or more communication units 640, one or more input devices 650, and one or more output devices 660.The processor 610 may be an actual or virtual processor and is capable of performing various processes based on programs stored in the memory 620. In a multiprocessor system, a plurality of processors performs computer-executable instructions in parallel to improve the parallel processing capability of the electronic device 600. The electronic device 600 shown in FIG. 6 may be used to implement the electronic device 110 of FIG. 1.

The electronic device 600 typically includes a plurality of computer storage media. Such media may be any available media accessible to the electronic device 600, including, but not limited to, volatile and non-volatile media, removable and non-removable media. The memory 620 may be volatile memory (e.g., register, cache, random access memory (RAM)), non-volatile memory (e.g., read-only memory (ROM), electrically erasable programmable read-only memory (EEPROM), flash memory), or some combination thereof. The storage device 630 may be a removable or non-removable medium and may include a machine-readable medium, such as a flash drive, a disk, or any other medium that may be capable of storing information and/or data and may be accessible within the electronic device 600.

The electronic device 600 may further include additional removable/non-removable, volatile/non-volatile storage media. Although not illustrated in FIG. 6, a disk drive for reading from or writing to a removable, non-volatile disk (e.g., a ‘floppy disk’) and an optical disk drive for reading from or writing to a removable, non-volatile optical disk may be provided. In these embodiments, each drive may be connected to a bus (not illustrated) by one or more data media interfaces. The memory 620 may include a computer program product 626 having one or more program modules that are configured to perform various methods or actions of various embodiments of the present disclosure.

The communication unit 640 implements communication with other electronic devices via a communication medium. Additionally, the functions of the components of the electronic device 600 may be implemented as a single computing cluster or a plurality of computing machines that are capable of communicating over a communication connection. Thus, the electronic device 600 may use logical connections to one or more other servers, networked personal computers (PCs), or a further network node to operate in a networked environment.

The input device 650 may be one or more input devices, such as a mouse, a keyboard, a tracking ball, and the like. The output device 660 may be one or more output devices, such as a monitor, a speaker, a printer, and the like. The electronic device 600 may also communicate, as desired, via the communication unit 640, with one or more external devices (not illustrated), external devices such as storage devices, display devices, etc., with one or more devices that enable a user to interact with the electronic device 600, or with any device that enables the electronic device 600 to communicate with one or more other electronic devices (e.g., a network card, modem, etc.) to communicate. Such communication may be performed via an input/output (I/O) interface (not illustrated).

According to an example implementation of the present disclosure, there is provided a computer-readable storage medium having computer-executable instructions stored thereon, where the computer-executable instructions are performed by a processor to implement the method described above. According to an example implementation of the present disclosure, there is also provided a computer program product, the computer program product being tangibly stored on a non-transient computer-readable medium and including computer-executable instructions, where the computer-executable instructions are performed by a processor to implement the methods described above.

Aspects of the present disclosure are described herein with reference to flowcharts and/or block diagrams of methods, apparatuses, devices, and computer program products implemented according to the present disclosure. It would be appreciated that each block of the flowchart and/or block diagram, and combinations of blocks in the flowcharts and/or block diagrams, may be implemented by computer readable program instructions.

These computer-readable program instructions may be provided to a processor of a general purpose computer, special purpose computer, or other programmable data processing apparatus to produce a machine, such that the instructions, when executed by a processor of a computer or other programmable data processing apparatus, produce means to implement the functions/acts specified in the flowchart and/or block diagram. These computer-readable program instructions may also be stored in a computer-readable storage medium that causes the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, function, and operation of possible implementations of systems, methods, and computer program products according to various implementations of the present disclosure. In this regard, each block in the flowchart or block diagram may represent a module, program segment, or part of an instruction that includes one or more executable instructions for implementing the specified logical function. In some alternative implementations, the functions noted in the blocks may also occur in a different sequence than noted in the figures. For example, two consecutive blocks may actually be performed substantially in parallel, which may sometimes be performed in the reverse sequence, depending on the function involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations would be apparent to those of ordinary skill in the art without departing from the scope and spirit of the various implementations illustrated. The determination of the terms used herein is intended to best explain the principles of the implementations, practical applications, or improvements to techniques in the marketplace, or to enable others of ordinary skill in the art to understand the various implementations disclosed herein.

What is claimed is:

1. A method for interface interaction, comprising:
presenting an interaction interface comprising an input control for inputting a prompt;
detecting whether information input in the input control comprises a target field of a predetermined type;
adjusting a display style of the target field in the input control in response to the input information comprising the target field of the predetermined type; and
providing auxiliary information associated with the target field in response to receiving a predetermined operation for the target field.

2. The method of claim 1, wherein the prompt is for describing an effect to be generated, and the target field of the predetermined type corresponds to an effect parameter for controlling an effect generation.

3. The method of claim 2, wherein the effect parameter comprises at least one of:
a first-type parameter related to a material content for generating an effect,
a second-type parameter related to an interaction process of the effect to be generated, or
a third-type parameter related to a processing logic of the effect to be generated.

4. The method of claim 1, wherein detecting whether the information input in the input control comprises the target field of the predetermined type comprises:
obtaining the input information in the input control; and
detecting, by using a first model, whether the input information comprises the target field of the predetermined type.

5. The method of claim 1, wherein adjusting the display style of the target field in the input control comprises:
presenting, in the input control, an interaction component corresponding to the target field, the interaction component displaying the target field.

6. The method of claim 1, wherein adjusting the display style of the target field in the input control comprises:
presenting, in the input control, an identification element corresponding to the target field, the identification element indicating a type of the target field.

7. The method of claim 6, wherein the identification element comprises a predetermined graphical element corresponding to the type.

8. The method of claim 1, wherein providing the auxiliary information associated with the target field comprises:
presenting an interaction panel corresponding to the target field in response to receiving the predetermined operation for the target field; and
providing, in the interaction panel, a set of candidate items associated with the target field as the auxiliary information.

9. The method of claim 8, further comprising:
updating the target field in the input control to a selected target candidate item in response to a selection of the target candidate item in the set of candidate items.

10. The method of claim 9, wherein the set of candidate items are generated by using a second model based on the input information or the target field.

11. The method of claim 1, wherein the auxiliary information comprises an interpreted content and/or modification suggestion for the target field.

12. An electronic device, comprising:
at least one processor; and
at least one memory coupled to the at least one processor and storing instructions for execution by the at least one processor, the instructions, when executed by the at least one processor, causing the electronic device to perform acts comprising:
presenting an interaction interface comprising an input control for inputting a prompt;
detecting whether information input in the input control comprises a target field of a predetermined type;
adjusting a display style of the target field in the input control in response to the input information comprising the target field of the predetermined type; and
providing auxiliary information associated with the target field in response to receiving a predetermined operation for the target field.

13. The electronic device of claim 12,wherein the prompt is for describing an effect to be generated, and the target field of the predetermined type corresponds to an effect parameter for controlling an effect generation.

14. The electronic device of claim 13, wherein the effect parameter comprises at least one of:
a first-type parameter related to a material content for generating an effect,
a second-type parameter related to an interaction process of the effect to be generated, or
a third-type parameter related to a processing logic of the effect to be generated.

15. The electronic device of claim 12,wherein detecting whether the information input in the input control comprises the target field of the predetermined type comprises:
obtaining the input information in the input control; and
detecting, by using a first model, whether the input information comprises the target field of the predetermined type.

16. The electronic device of claim 12,wherein adjusting the display style of the target field in the input control comprises:
presenting, in the input control, an interaction component corresponding to the target field, the interaction component displaying the target field.

17. The electronic device of claim 12,wherein adjusting the display style of the target field in the input control comprises:
presenting, in the input control, an identification element corresponding to the target field, the identification element indicating a type of the target field.

18. The electronic device of claim 17, wherein the identification element comprises a predetermined graphical element corresponding to the type.

19. The electronic device of claim 12,wherein providing the auxiliary information associated with the target field comprises:
presenting an interaction panel corresponding to the target field in response to receiving the predetermined operation for the target field; and
providing, in the interaction panel, a set of candidate items associated with the target field as the auxiliary information.

20. A non-transitory computer-readable storage medium having computer-executable instructions stored thereon, the computer-executable instructions being executable by a processor to perform acts comprising:
presenting an interaction interface comprising an input control for inputting a prompt;
detecting whether information input in the input control comprises a target field of a predetermined type;
adjusting a display style of the target field in the input control in response to the input information comprising the target field of the predetermined type; and
providing auxiliary information associated with the target field in response to receiving a predetermined operation for the target field.
